(19) United States
(12) Patent Application Publication
(10) Pub. No.: US 2007/0187446 A1
(43) Pub. Date: Aug. 16, 2007

(54) IMPLEMENT HOLDER

(76) Inventor: Simeon Marks, London (GB)

Correspondence Address: THE LAW OFFICES OF THOMAS L. ADAMS, 120 EAGLE ROCK AVENUE, P.O. BOX 340, EAST HANOVER, NJ, 07936, US

(21) Appl. No.: 11/736,752

(22) Filed: Apr. 18, 2007

Related U.S. Application Data
(63) Continuation of application No. 10/415,690, filed on Oct. 3, 2003.

(30) Foreign Application Priority Data
Nov. 2, 2001 (GB) PCT/GB01/04874
Nov. 2, 2002 (GB) 0026770.8

(51) Int. Cl. A61C 19/00; A41D 19/00

(52) U.S. Cl. 224/217

(57) ABSTRACT

A holder for fitting around a user's finger and holding an implement thereto, the holder comprising a band at least a portion of which is elastic, the band having a first portion (11) and a second portion (13), wherein the first and second portions are of substantially the same width or wherein one of said first and second portions is narrower in width and the other is broader in width, and a least one reinforcing member (12).

The present invention relates to a holder for fitting around a user's finger and holding an implement thereto.

There are a number of devices known for attachment of a writing implement to a user's finger or hand. Conventionally these devices comprise a rigid band which fits onto the finger or is strapped around a hand, and have attached a discrete, smaller band through which a pencil or other such writing implement can be inserted such that the writing implement is held in the region of the user's hand.

However, there are a number of drawbacks associated with such known devices. For example, they can be uncomfortable to wear, and may also restrict movement of the fingers or hand, particularly those devices that completely encircle the user's palm. Naturally, this is a considerable disadvantage for those users requiring a high degree of flexibility either when using the implement or when the implement is not in use but is merely attached to the user's hand. Moreover, in many cases, these known devices merely provide a means of attaching an implement in the region of a user's hand, and may require further adjustment by the user, using his fingers and/or his other hand, in order to move the implement up or down as necessary within its holder and to correctly orient the implement for use. Further, the known devices only allow for one implement to be attached in the region of the user's hand at any time; no provisions are made for multiple implements.

It is therefore an object of the present invention to seek to overcome these disadvantages.

According to the present invention, there is provided a holder for fitting around a user's finger and holding an implement thereto, the holder comprising a band at least a portion of which is elastic, the band having a first portion and a second portion, wherein the first and second portions are of substantially the same width or wherein one of said first and second portions is narrower in width and the other is broader in width, and at least on reinforcing member.

In use, the holder secures an implement to the user's index finger so that the implement can be grasped and released repeatedly depending on whether or not the user requires the implement. When the user no longer requires use of the implement, he can simply release his grip, the implement being retained by the holder ready for the user to take up again. Moreover, the holder secures the implement to the user's finger in an orientation such as to facilitate the correct positioning of the implement in the user's hand when the user grasps the implement. The holder of the present invention can accommodate more than one implement, thus allowing the user to switch from one implement to another with ease, and without the need to drop one implement in order to pick up another. This multitasking capability is advantageous for, for example, an artist when drawing, as it is not necessary for the artist to put down, for example, a paintbrush or pen in order to carry out other tasks, for example erasing pencil lines.

Other potential uses of the holder of the present invention include use by make-up artists requiring access to a range of different brushes, use by tattoo artists, and use as a teaching tool, for example to help to teach children to write or to aid persons who have difficulty holding certain implements, such as writing implements or chopsticks.

The elastic portion of the band renders the band expandable, so that the holder can fit onto and grip around fingers of differing sizes.

In use, the first portion is preferably located over the top of a finger, whilst the second portion is located generally on the underside of the finger.

The reinforcing member may be a rigid pad against which the user's thumb can press to stabilize the implement in use and provide greater control. The reinforcing member prevents the band from becoming twisted during fitting onto, or removal from, the user's finger.

The first and second portions may be of substantially the same width. Alternatively, the width of one of the first or second portions may be smaller than that of the other portion. In this way, it can be appreciated that the narrower portion allows the user freedom to bend his finger, whilst the broader portion provides a base for securely holding an implement against a finger.

Preferably, where present, at least the broader of the first and second portions of the band is elastic. More preferably, the band comprises a continuous closed loop of elastic material.

Alternatively, the band may comprise one or more pieces of material that can be attached to itself or one another respectively to form a closed loop of variable size. The means of attachment may comprise, for example, Velcro, press studs, hooks and eyes, or a buckle.

The band may be provided with at least one cut, preferably, where present, in the broader of the first and second portions and through which, for ease of insertion, the implement can be inserted. The second portion of the band may be provided with at least two cuts, to thereby form a loop through which loop the implement may be inserted.

Alternatively, the holder may further comprise a strip of at least partially elastic material which forms a loop with the band, through which loop the implement can be inserted.

In preferred embodiments, the band is provided with two reinforcing members. It is further preferred that the two reinforcing members are diametrically opposed to one another.

Conveniently, the at least one reinforcing member comprises means for identification of origin, for example a trade mark or other marketing material.

Embodiments of the present invention will now be described in detail with reference to the accompanying drawings, in which:

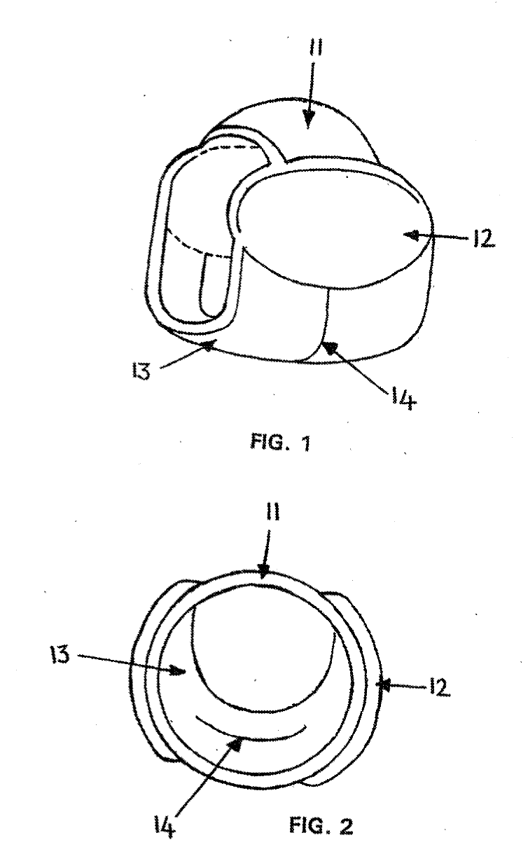

FIG. 1 is a perspective view of a first embodiment of the holder of the present invention.

FIG. 2 is a front view of the holder of FIG. 1.

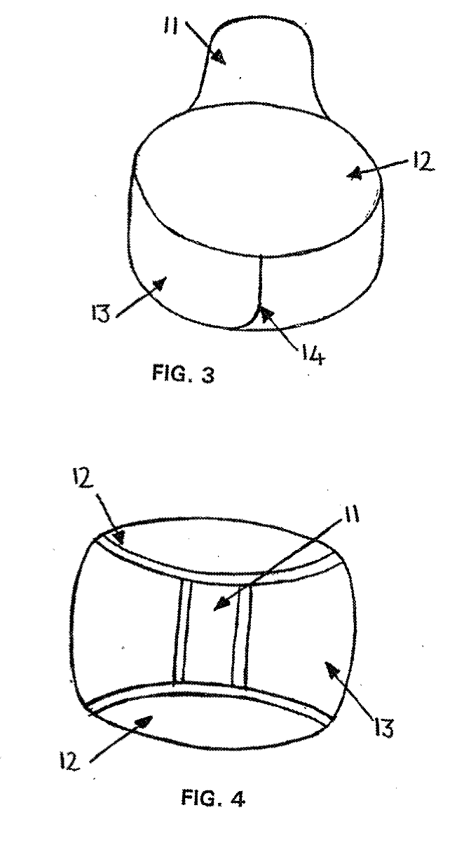

FIG. 3 is a side view of the holder of FIGS. 1 and 2.

FIG. 4 is a top view of the holder of FIGS. 1 to 3.

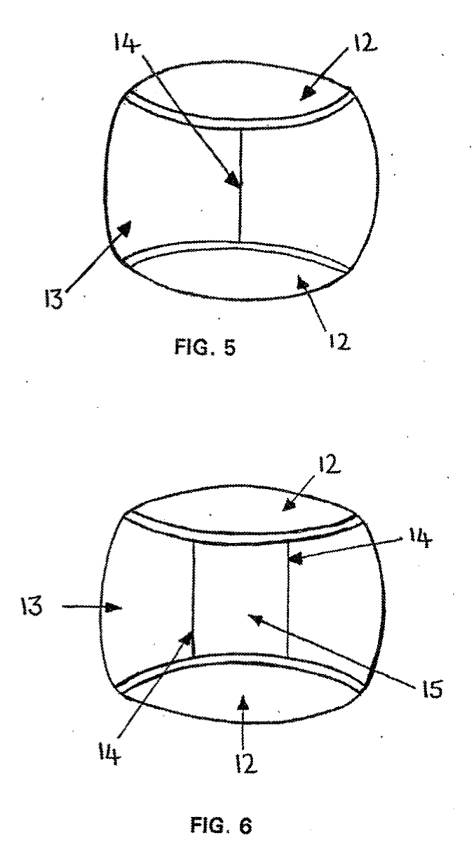

FIG. 5 is a bottom view of the holder of FIGS. 1 to 4.

FIG. 6 is a bottom view of a second embodiment of the holder of the present invention.

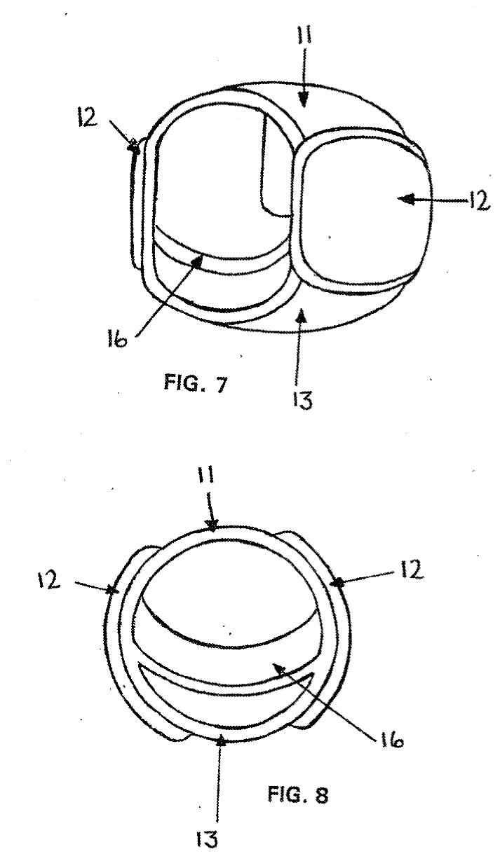

FIG. 7 is a perspective view of a third embodiment of a holder of the present invention.

FIG. 8 is a front view of the holder of FIG. 7.

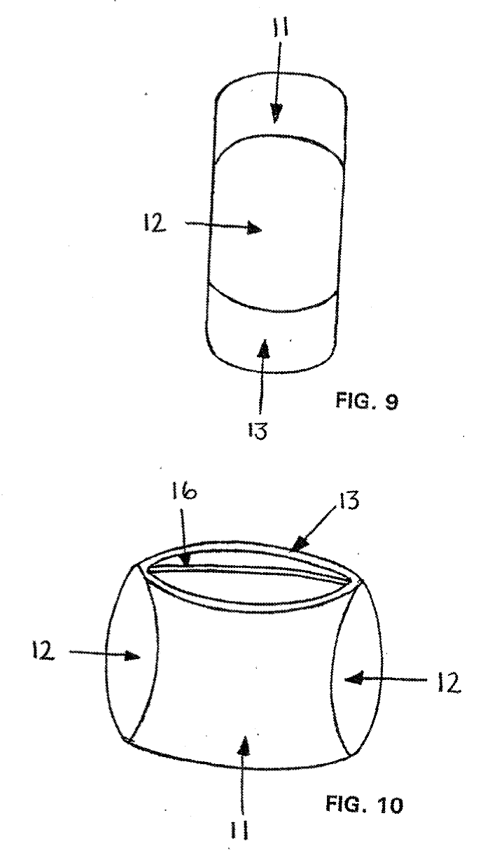

FIG. 9 is a side view of the holder of FIGS. 7 and 8.

FIG. 10 is a perspective side view from above of the holder of FIGS. 7 to 9.

Referring to FIGS. 1 to 5, a first embodiment of the holder of the present invention comprises a band comprising a first portion 11 and a second portion 13. The first portion 11 and the second portion 13 are made of elastic material and form a continuous loop. The second portion 13 has a cut 14 therein, through which in use an implement can be inserted, to thereby grip the implement between the second portion 13 and the finger of a user. The band further includes two reinforcing members 12, which are diametrically opposed on either side of the band. The reinforcing members 12 can comprise means for indication of origin, for example a trade mark or other marketing material.

Referring to FIG. 6, a second embodiment of the holder of the present invention is substantially the same as the first embodiment, but has two cuts 14 in the second portion 13 forming a loop 15, rather than the single cut 14 of the first embodiment. An implement to be held can thus be passed through the loop 15 so as to be held by the holder.

Referring to FIGS. 7 to 10, a third embodiment of the holder of the present invention is substantially the same as the first and second embodiments described above, but further comprises a strip of material 16 which forms a loop with the band. In a similar way to the loop 15 of the second embodiment described above, an implement to be held can be passed through the loop 16 so as to be held by the holder.

Although the holder of the present invention is directed to use for holding a drawing/writing implement, it will be appreciated by those skilled in the art that it may also be used for holding any other suitable hand-held implement, and may be particularly beneficial in teaching children to write.

1. A holder for fitting around a user's finger and holding an implement thereto, the holder comprising a band at least a portion of which is elastic, and at least one reinforcing member.

2. A holder according to claim 1 wherein the band comprises a first portion and a second portion, the first and second portions being of substantially the same width.

3. A holder according to claim 1 wherein the band comprises a first portion and a second portion, the width of one of the first or second portions being smaller than that of the other portion.

4. A holder according to claim 3 wherein at least the broader portion is elastic.

5. A holder according to claim 4 wherein the band comprises a continuous closed loop of elastic material.

6. A holder according to any one of claims 1 to 4 wherein the band comprises one or more pieces of material that can be attached to one another to form a closed loop of variable size.

7. A holder according to claim 6 wherein the means of attachment is velcro, press studs, hooks and eyes or a buckle.

8. A holder according to claim 1 wherein the band is provided with at least one cut through which the implement can be inserted.

9. A holder according to claim 8 wherein the band is provided with at least two cuts, thereby forming a loop through both of which cuts the implement can be inserted.

10. A holder according to claim 8 or 9 wherein the width of one of the first or second portions is smaller than that of the other portion, and the cut(s) is provided in the broader portion.

11. A holder according to any one of claims 1 to 5 which further comprises a strip of at least partially elastic material which forms a loop with the band through which loop the implement can be inserted.

12. A holder according to claim 1 wherein the band is provided with two reinforcing members.

13. A holder according to claim 11 wherein the two reinforcing members are diametrically opposed to one another.

14. A holder according to claim 1 wherein the at least one reinforcing member comprises means for identification of origin.

15. (canceled)
